(19) United States
(12) Patent Application Publication
(10) Pub. No.: US 2001/0049613 A1
(43) Pub. Date: Dec. 6, 2001

(54) Synchronizing reservation database

(76) Inventors: Henry T. Gramann III, Houston, TX (US); Jason H. Moore, Houston, TX (US); Stephanie L. Gusmeri, Tomball, TX (US)

Correspondence Address: Timothy N. Trop, TROP, PRUNER & HU, P.C., 8554 Katy Freeway, Ste. 100, Houston, TX, 77024, US

(21) Appl. No.: 09/778,567

(22) Filed: Feb. 7, 2001

Related U.S. Application Data
(60) Provisional application No. 60/185,786, filed on Feb. 29, 2000.

(51) Int. Cl. G06F 17/60

(52) U.S. Cl. 705/5

(57) ABSTRACT

A reservation system synchronization process that synchronizes scheduling, customer, and configuration information and reduces conflicts for calendar-driven consumer service businesses. The process keeps business calendar information on both a local computer system, residing at the local business facility, and a webserver attached to the Internet, each of which is self-sustaining in the event of a computer system or network connection failure. A polling process synchronizes the reservation information entered into the databases on each computer system. The reservation system synchronization process automatically resolves conflicts and avoids information loss.

### CROSS-REFERENCE TO RELATED APPLICATIONS

The present application claims priority under 35 U.S.C. §119(e) to U.S. Provisional Patent Application Ser. No. 60/185,786, entitled “Reservation System,” filed Feb. 29, 2000.

### BACKGROUND

This invention relates to reservation systems and, more particularly, to making web-based reservations.

Many consumer service businesses are calendar-driven. Profitability and customer satisfaction are dependent upon the ability of the business to move customers through in a way that is timely yet results in a pleasant customer experience. Such businesses include but are not limited to restaurants, who must turn tables while providing a pleasant dining experience; golf courses, who must keep as many golfers on the course while ensuring a positive sporting experience; and salons, who must keep their chairs full while providing personalized grooming services. These are merely examples of the many enterprises whose consumer business is calendar-driven.

Each of these businesses has historically had to employ one or more individuals whose functions may have included taking incoming phone calls or facsimile transmissions, updating and maintaining the calendar, and ensuring that customers were served in a timely way. These individuals often have other responsibilities as well, ranging from service and sales of additional products (such as golf attire and equipment in a pro shop to personal care products in a salon) to customer relationship management.

Many attempts have been made to use automation to simplify, expedite or increase the efficiency of such business' calendars. For example, in the late 1970s, restaurants began using systems with lights to indicate table availability. Such systems, however, still required a separate tablet or notepad for listing the names of diners with reservations. New software systems were introduced in the late 1980s which used electronic means for keeping appointment books at businesses such as salons, but still required the customers to telephone and the employees of the business to input the appointment information. In the 1990s, the Internet spawned the creation of reservation systems over this vast computer network, but difficulties and conflicts arose between information input at the local business and that entered over the Internet.

Systems exist whereby an individual wishing to make a reservation at a facility utilizing the Internet visits the facility's web site and chooses an option for making a reservation. Most of the currently available systems then use one of three methods for entering and confirming the desired reservation.

One method is via email, which requires human intervention at the business end: someone to receive the emailed request, look at the calendar for availability and send an email message back to the prospective customer. While this allows the business employee to respond to the request at a time of his or her choosing (rather than immediately answering a ringing telephone), it does not significantly reduce the amount of time the business spends processing the reservation request.

Another method is to allow the business' calendar to reside on a webserver: the customer accesses the website and is able to view and input calendar information. Conflicts, however, can arise when a business employee at the local facility is attempting to respond to an on-site customer request for a reservation at a time already booked via the Internet but not yet updated to the local system. Worse, should the business' Internet connection be lost, even for a short time, calendar information is lost and customer dissatisfaction would be inevitable.

A third method is to keep the calendar information on a local system, but, as with keeping the calendar on a webserver, conflicts and lost information are again inevitable.

This, there is a continuing need to provide an environment in which both site-based and web-based reservations may be made substantially in real time.

### SUMMARY OF THE INVENTION

In one embodiment, a method for scheduling reservations comprises storing a site-based reservation on a primary database, storing a web-based reservation on a secondary database, and automatically and periodically synchronizing the primary database with the secondary database.

Advantages offered by some embodiments of the invention may include one or more of the following. Reservations may be made either from a local system (site-based) or through a web server (web-based). Databases on the local and server systems are updated such that conflicts are resolved in favor of the local system, enhancing business confidence.

Other features and advantages other features and advantages will become apparent from the following description, from the drawings, and from the claims.

### BRIEF DESCRIPTION OF THE DRAWINS

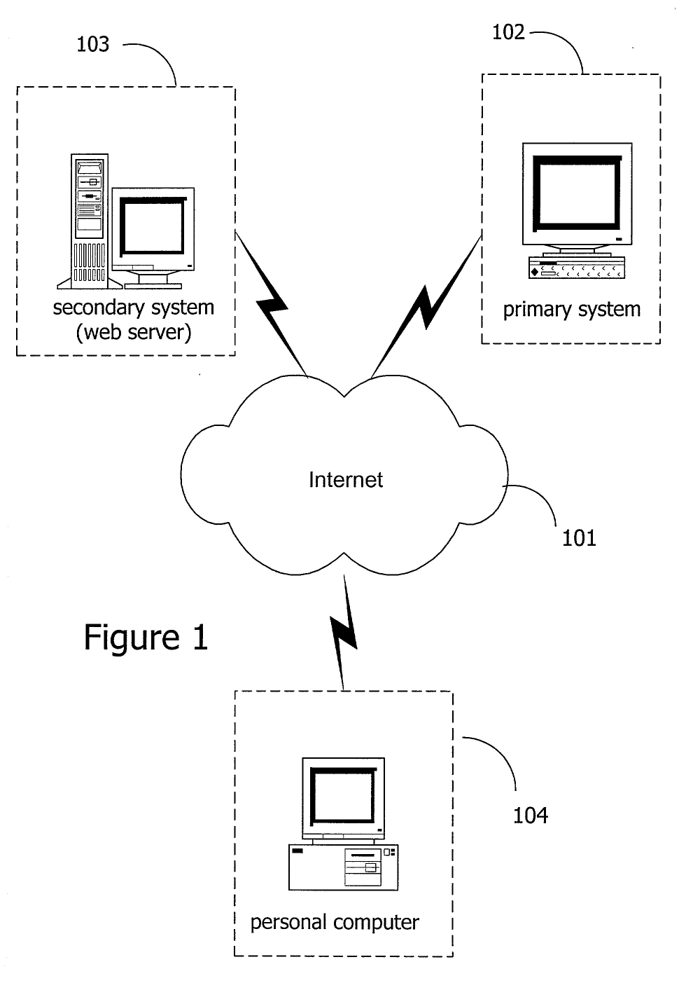

FIG. 1 is a block diagram of a network environment for implementing one embodiment of the invention;

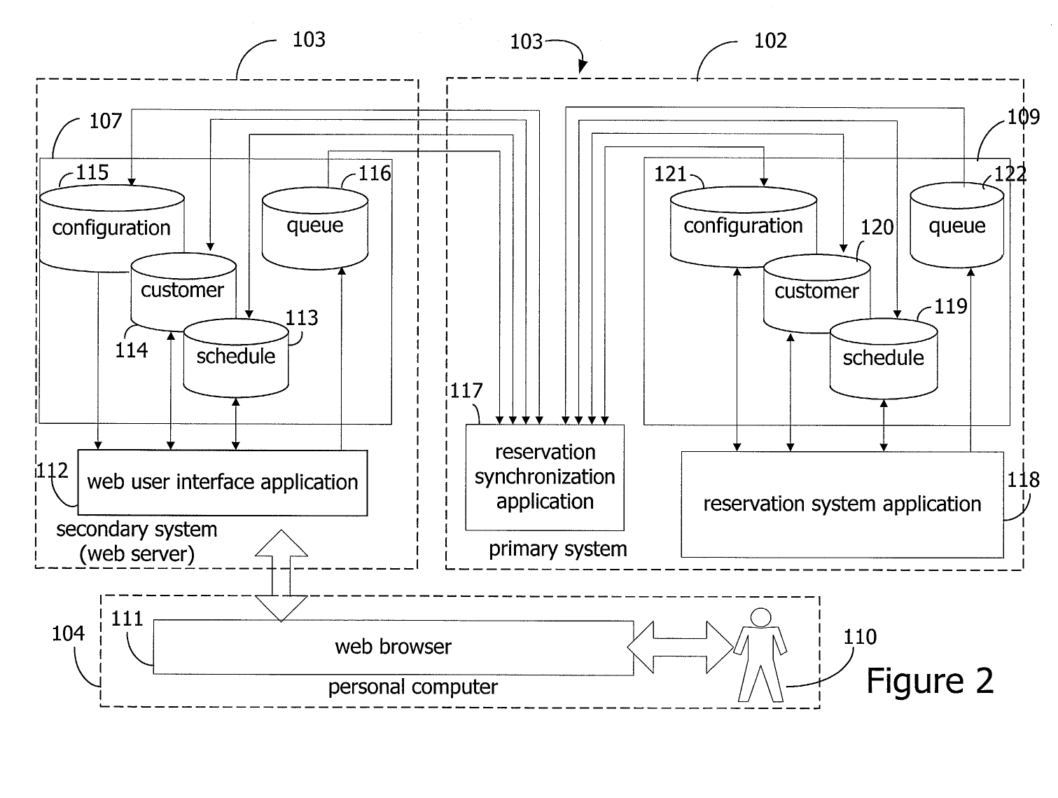

FIG. 2 is a block diagram of a system according to one embodiment of the invention;

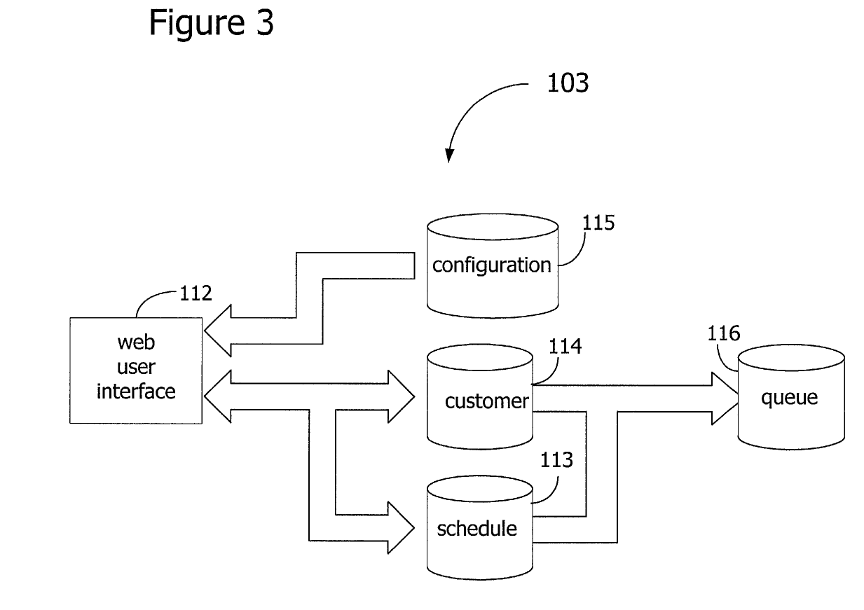

FIG. 3 is a block diagram of the relationship between the web user interface application and the database on the secondary system according to one embodiment of the invention;

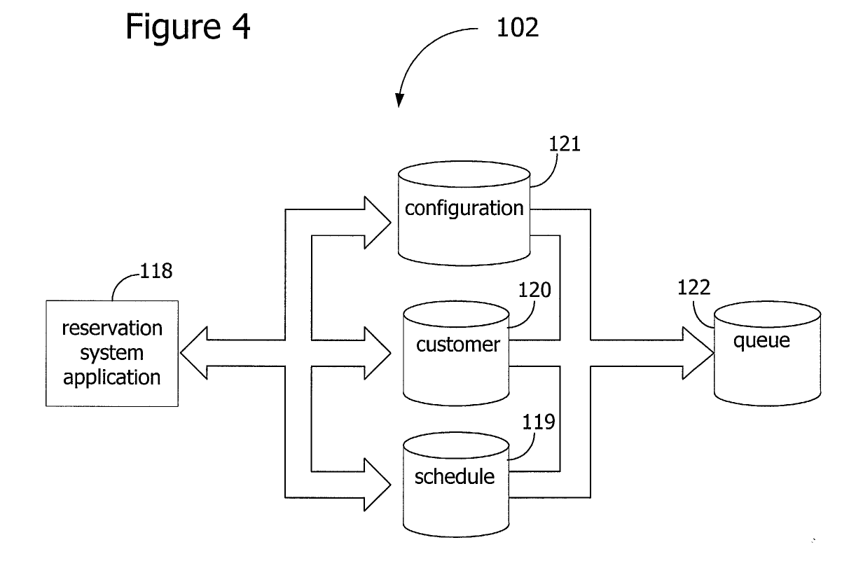

FIG. 4 is a block diagram of the relationship between the reservation system application and the database on the primary system according to one embodiment of the invention;

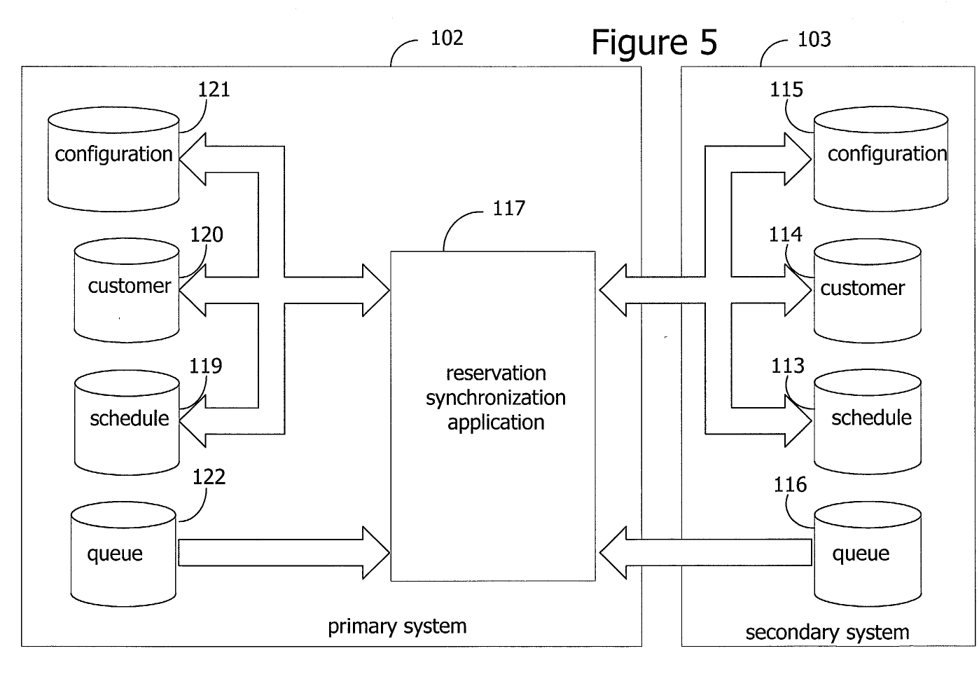

FIG. 5 is a block diagram of the relationship between the reservation synchronization application and the databases on the secondary and primary systems according to one embodiment of the invention;

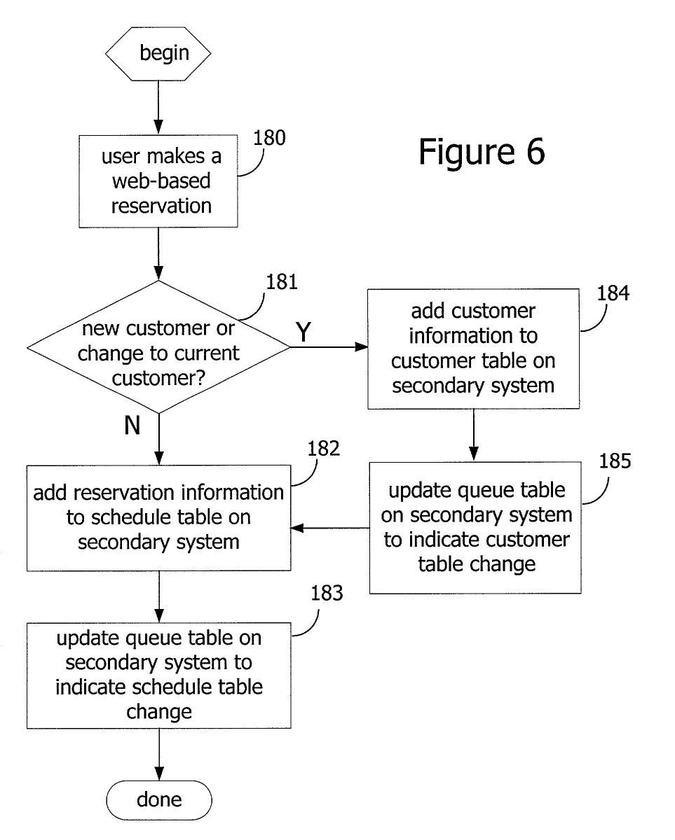

FIG. 6 is a flowchart illustrating operation of the web user interface application according to one embodiment of the invention;

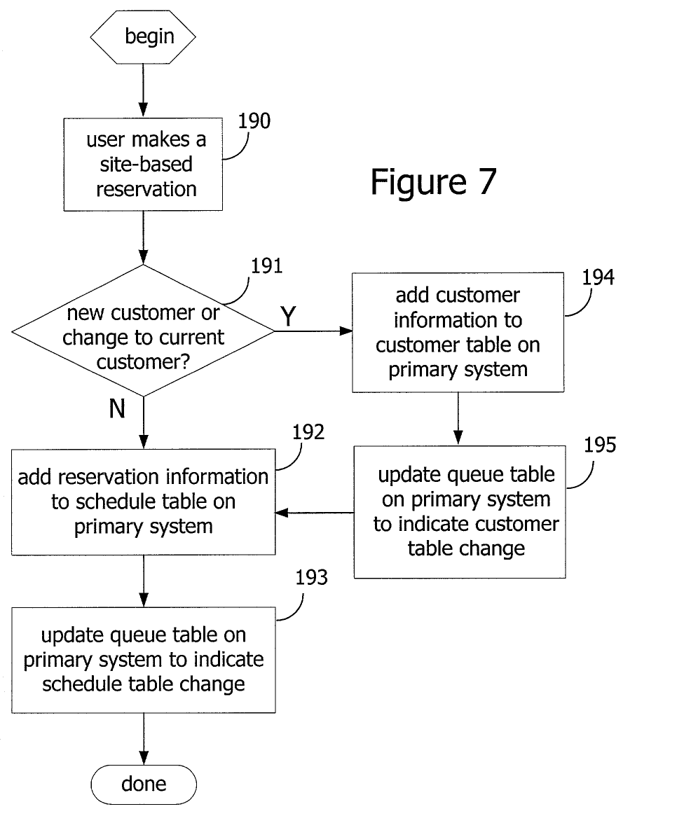

FIG. 7 is a flowchart illustrating operation of the reservation system application according to one embodiment of the invention; and

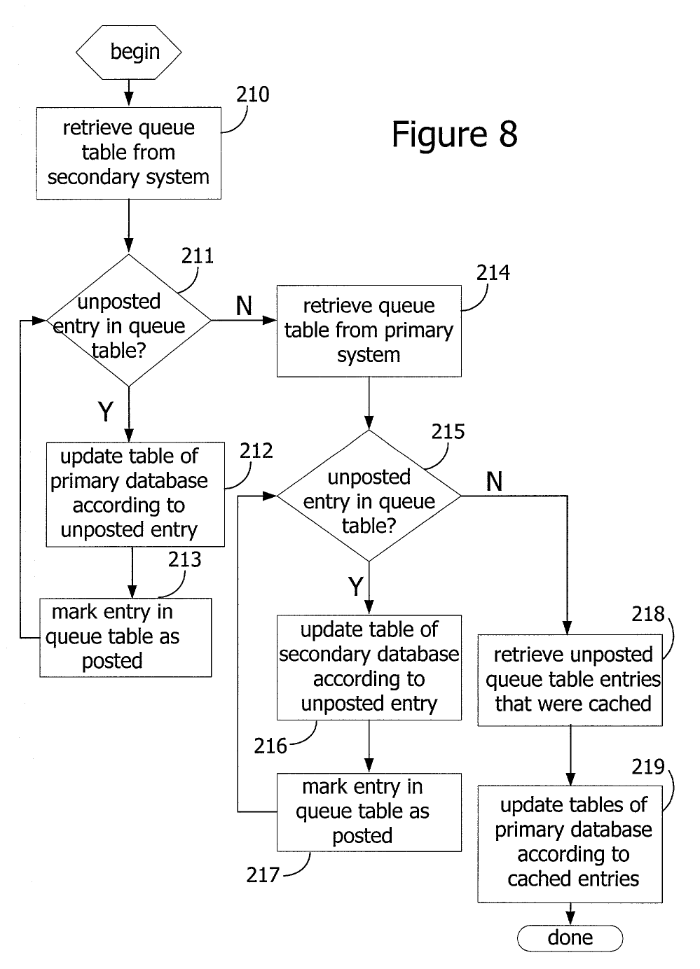

FIG. 8 is a flowchart illustrating operation of the reservation synchronization application according to one embodiment of the invention.

### DETAILED DESCRIPTION

As will be described in detail below with respect to the Figures, a preferred embodiment of the invention includes a user interface which organizes information into a consistent presentation of menu selections allowing the user to search on and select a business with which the user desires to make a reservation and then to make such a reservation by communicating electronically and automatically with the business over the Internet. Such businesses may include but are not limited to restaurants, golf courses, salons, hotels and other calendar-driven consumer services businesses. The explanation below describes the reservation functionality as applied to making a restaurant reservation, although this should not be construed to imply that restaurant reservations are the only implementation of the system.

FIG. 1 is a schematic diagram that illustrates the general hardware configuration utilized by online users and calendar-driven consumer service businesses each accessing the Internet in order to automate the process of making a reservation. As is well understood by those skilled in the art, the Internet comprises a plurality of geographically distributed servers, interconnected by a high-speed data backbone.

For example, in FIG. 1, the online user employs a personal computer (PC) 104, whether stand-alone or connected to a local area network, to access the Internet 101. The user PC 104 may include a variety of software and hardware and is configured to allow the communication with and exchange of information with the numerous servers comprising the Internet 101.

Similarly, the calendar-driven consumer service business utilizes a PC, whether stand-alone or connected to a local area network, hereinafter called the primary system 102, to access the Internet 101. Like the PC 104, the primary system 102 may include a variety of software and hardware, configured to allow the communication and exchange of information with other entities on the Internet 101. In one embodiment, such configuration includes database software and capabilities for implementing the automated reservation system synchronization process as described in detail below. Although a single primary system 102 is depicted in FIG. 1, the illustrated network may alternatively include multiple primary systems 102, as desired, for simultaneously supporting multiple calendar-driven consumer service businesses.

Additionally, a third computer system, hereinafter known as the secondary system or web server 103, acts as the intermediary between the user's PC 104 and the business' PC, or primary system 102. In one embodiment, the secondary system 103 includes specialized software configuring a web user interface application commonly known as a website. In one embodiment, the user accesses the website to secure a reservation at one of the calendar-driven consumer service businesses, such as at a restaurant. The website is accessible to a user of the personal computer 104 connected to the Internet 101.

According to one embodiment, both the primary system 102, ostensibly the site of the calendar-driven consumer service business, and the secondary system 103, the site of the website, each include databases for storage of information relevant to the reservation. As described below, the redundant databases of both the primary system 102 and the secondary system 103 are synchronized. In this manner, the integrity of the reservation system is maintained for both the on-line user and the restaurateur who accesses the primary system 102.

FIG. 2 is a block diagram of a reservation system 100 according to one embodiment. A user 110 of the PC 104 utilizes a software program commonly known as a web browser 111 to communicate with the secondary system 103, such as by receiving a web page into the web browser 111.

In one embodiment, the secondary system 103 includes a web user interface application 112. The web user interface application 112 includes software configured to provide a user interface with which the user 110 may access the reservation system 100. As is common and well-known to those skilled in the art, many web users, utilizing a variety of web browsers, may simultaneously access the web user interface application 112. The web user interface application 112 may likewise simultaneously provide information to the many web users.

In one embodiment, the secondary system 103 further includes a database 107, or secondary database 107, including software for maintaining various tables. As described in detail below, the database 107 is synchronized with a database 109 which resides on the primary system 102, also known as the primary database 109. The contents of each database 107 and 109 may vary depending upon the application of the reservation system 100. The following examples describe the reservation system 100 as used in a restaurant, although this setting is merely illustrative. The reservation system 100 may be employed in a variety of calendar-driven consumer service businesses.

In one embodiment, the secondary database 107 includes one or more scheduling tables 113. The scheduling table 113 includes information relevant to scheduling a restaurant reservation. Thus, in one embodiment, the scheduling table 113 includes fields for the date, the time, the name of the party, and the number of people in the party. In one embodiment, the web user interface application 112 both retrieves information from and publishes information to the scheduling table 113.

The secondary database 107 further includes one or more customer tables 114, according to one embodiment. The customer table 114 includes information about the customer. Thus, in one embodiment, the customer table 114 includes fields for the customer's name, address, phone number, email address, and smoking preference. In one embodiment, the web user interface application 112 both retrieves information from and publishes information to the customer table 114.

The secondary database 107 further includes one or more configuration tables 115. In one embodiment, the configuration table 115 includes characteristics about the restaurant that may facilitate reservation management. For example, in one embodiment, the configuration table 115 includes fields for reservation times available (e.g., from 5 p.m. until 10 p.m.) and the maximum reservation capacity (e.g., the number of diners which may be scheduled at any given time). In one embodiment, the web user interface application 112 retrieves information from the configuration table 115 but does not supply information to the configuration table 115.

The secondary database 107 also includes a queue table 116, according to one embodiment. The queue table 116 essentially keeps track of changes made to either the schedule table 113 or the customer table 114. Changes to the tables 113 and 114 may include table additions, table deletions, or modifications to existing table entries. In one embodiment, the entries in the queue table 116 are chronological. The queue table 116 may thus provide a time-based history of access to the secondary database 107.

In one embodiment, the queue table 116 further associates a flag with each entry in the queue table 116. The flag identifies whether the entry has been processed or not. Each time the customer table 114 or schedule table 113 is accessed, the web user interface application 112 writes to the queue table 116. Likewise, when an entry of the queue table 116 is accessed during synchronization, its associated “posted” flag may be set.

The primary system 102 includes a reservation system application 118, according to one embodiment. The reservation system application 118 may include a variety of software, such as database software configured to retrieve information from and publish information to the primary database 109.

In one embodiment, the primary database 109 is a mirror image of the database 107. Accordingly, the primary database 109 includes one or more scheduling tables 119, one or more customer tables 120, one or more configuration tables 121, and a queue table 122. In one embodiment, the reservation system application 118 may both retrieve information from and publish information to the scheduling tables 119, the customer tables 120, and the configuration tables 121.

Like the queue table 116 of the secondary system 103, the queue table 122 includes entries that chronologically identify changes made to the other tables in the primary database 109. In one embodiment, the reservation system application 118 writes to the queue table 122 each time a change is made to either of the customer table 120 or the scheduling table 119.

A reservation synchronization application 117 resides on the primary system 102, for synchronizing between the database 107 on the secondary system 103, and the database 109 on the primary system 102. In one embodiment, the reservation synchronization application 117 periodically polls both databases 107 and 109 such that both the primary system 102 and the second system 103 are synchronized. The reservation synchronization application 117 may retrieve information from and publish information to each of the schedule tables 113 and 119, the customer tables 114 and 120, and the configuration tables 115 and 121, for both the primary 102 and the secondary 103 systems. Likewise, in one embodiment, the reservation synchronization application 117 receives and processes the information from the queue table 116 on the secondary system 103 as well as from the queue table 122 on the primary system 102.

The reservation system 100 thus processes a redundant database, wherein the reservation synchronization application 117 periodically polls each database 107 and 109 and performs updates where changes are detected.

FIG. 3 illustrates the relationship between the web user interface application 112 and the schedule 113, customer 114, queue 116 and configuration 115 tables on the secondary system 103. According to one embodiment, the web user interface application 112 retrieves information from and publishes information to the schedule 113 and customer 114 tables, as illustrated. The information in the queue table 116 is derived from the information entered into the schedule 113 and customer 114 tables. The web user interface application 112 retrieves information from, but does not publish information to, the configuration table 115, according to one embodiment.

FIG. 4 illustrates the relationship between the reservation system application 118 and the schedule 119, customer 120, configuration 121 and queue 122 tables on the primary system 102, according to one embodiment. As illustrated, the reservation system application 118 retrieves information from and publishes information to the schedule 119, customer 120 and configuration 121 tables. The information in the queue table 122 is derived from the information entered into the schedule 119, customer 120 and configuration 121 tables.

FIG. 5 illustrates the relationship between the reservation synchronization application 117 and the schedule 119, customer 120, configuration 121 and queue 122 tables on the primary system 102 as well as the schedule 113, customer 114, configuration 115 and queue 116 tables on the secondary system 103. As illustrated, the reservation synchronization application 117 retrieves information from the queue tables 122 and 116 on the primary 102 and secondary 103 systems, respectively. The reservation synchronization application 117 retrieves information from and publishes information to the schedule 113, customer 114 and configuration 115 tables on the secondary system 103. The reservation synchronization application 117 also retrieves information from and publishes information to the schedule 119, customer 120 and configuration 121 tables on the primary system 102.

In one embodiment, each of the aforementioned tables is identical on the primary 102 and secondary 103 systems. The tables and fields are a representation of a restaurant reservation system and are used as an example of only one potential application of the reservation synchronization polling process.

As explained above, the schedule tables 113 and 119 include information specific to a reservation. Table 1 lists entries in the schedule tables 113 and 119 used to make a restaurant reservation, according to one embodiment:

TABLE 1
SCHEDULE TABLE

| Field | Data Type | Purpose |
|---|---|---|
| ID | Numeric | Unique identifier for each entry |
| | | in the schedule table |
| Epoch | Date/time | Date and time of the reservation |
| Partysize | Numeric | Number of individuals covered |
| | | by the reservation |
| Comment | Memo | Additional information |
| Customer ID | Numeric | Unique identifier associated with |
| | | an individual entry in the |
| | | customer table(s) |

The customer tables 114 and 120 provide specific customer information, in one embodiment. Table 2 lists possible entries in the customer tables 114 and 120 for identifying each restaurant customer:

TABLE 2
CUSTOMER TABLE

| Field | Data Type | Purpose |
|---|---|---|
| ID | Numeric | Unique identifier for each entry in |
| | | the customer table |
| Lastname | String | Last name of the customer |
| Firstname | String | First name of the customer |
| Address | String | Number and street address of the customer |
| City | String | City of customer residence |
| State | String | State of customer residence |
| Zip | String | Zip code of customer residence |
| Phone | String | Customer telephone number |
| Smoking | Boolean | Preference for smoking or nonsmoking seating |

The configuration tables 115 and 121 provide the reservation parameters specific to the local site. Table 3 includes fields for the configuration tables 115 and 121, according to one embodiment:

TABLE 3
CONFIGURATION TABLE

| Field | Data Type | Purpose |
|---|---|---|
| ID | Numeric | Unique identifier for each entry in the |
| | | configuration table |
| Time | Date/time | Potential times for which reservations can |
| | | be made |
| MaxReservations | Numeric | The maximum number of reservations |
| | | that can be entered for any given time |

The queue tables 116 and 122 include information about changes that have been made to the other tables. In Table 4, the queue tables 116 and 122 contain the following fields, according to one embodiment:

TABLE 4
QUEUE TABLE

| Field | Data Type | Purpose |
|---|---|---|
| ID | Numeric | Unique identifier for each entry in the queue table |
| SQL | String | Structured Query Language command issued to |
| | | database |
| Posted | Boolean | Indicates whether SQL command has been |
| | | processed |

FIG. 6 is a flow chart illustrating operation of the reservation system 100 according to one embodiment. In this example, a reservation is made by the user 110, using the web browser 111 on the personal computer 104 (see FIG. 2). The operations of FIG. 6 are thus invoked by the web user interface application 112, residing on the secondary system 103.

The user 110 makes a web-based reservation (block 180), such as by filling in a form of a graphical user interface (GUI) in the web browser 111. The reservation system 100 determines whether the user 110 is in the secondary database 107 (diamond 181). Because the user 110 is invoking the web-based feature of the reservation system 100, the secondary database 107 is scanned for a customer match, according to one embodiment.

If the customer is in the secondary database 107, the schedule table 113 is updated with reservation information supplied by the user 110 (block 182). Next, the queue table 116 is updated, to indicate that the schedule table 113 has changed (block 183).

If, instead, a new customer is requesting the reservation, the customer information, in one embodiment, is first added to the customer table 114 (block 184). The queue table 116 is then updated, to indicate that the customer table 114 has changed (block 185). The schedule table 113 is then updated with the reservation information (block 182) and the queue table 116 is updated (block 183).

In one embodiment, the operations of FIG. 6 are performed using a series of Structured Query Language (SQL) commands. For example, both the customer 114 and schedule 113 tables may be updated by issuing an appropriate “SQL INSERT” command. The SQL INSERT command causes the relevant information to be stored in the appropriate tables of the secondary database 107. Additionally, each SQL INSERT statement may itself be a table entry in the queue table 116. In this manner, the queue table 116 includes a chronological listing of all operations performed by the web user interface application 112, in entering the reservation into the secondary database 107.

FIG. 7 is a flow chart illustrating operation of the reservation system 100, this time, where the reservation is made on the primary system 102, e.g. at the restaurant site. In one embodiment, the operations of FIG. 7 are invoked by the reservation system application 118.

A reservation is entered into the primary system 102, such as by a restaurant employee receiving a call-in from a customer (block 190). The reservation system application 118 determines whether or not the reservation is being made by a new customer (diamond 191). If so, the new customer information is added to the customer table 120 on the primary system 102 (block 194). Likewise, the queue table 122 is updated to indicate that a change was made to the customer table 120 (block 195).

If, instead, the reservation is for a customer already in the primary database 109, the reservation information is stored in the schedule table 119 of the primary system 102 (block 192). Likewise, the queue table 122 is updated to indicate the change to the scheduling table 119 (block 193).

In one embodiment, the operations of FIG. 7 are performed using SQL commands. For example, where a change to the customer table 120 or the schedule table 119 is made, a SQL INSERT statement is executed against the relevant table of the primary database 109. The reservation system application 118 then adds the SQL INSERT statement to the queue table 122. Using SQL, the queue table 122 may at all times maintain a history of operations performed on the other tables of the primary database 109.

FIG. 8 is a flow chart illustrating operation of the reservation system 100 to synchronize the primary 102 and secondary 103 systems, according to one embodiment. The synchronization is invoked by the reservation synchronization application 117, which utilizes polling to synchronize each of the tables in the secondary database 107 with each of the tables in the primary database 109.

The synchronization is performed at regular intervals to reduce conflicts, in one embodiment. The intervals may vary according to business requirements and preferences, such as to minimize the potential for conflicts. In one embodiment, the polling is performed every fifteen seconds. The time for performing the operations of FIG. 8 vary, depending upon the amount of information in each table, the connection speed of the primary system 102, and other factors. Likewise, the time interval may be fixed or may be variable, in some embodiments. Alternatively, the time interval may be event-driven, such as where synchronization is performed following an update, or after every ten updates, for example.

The reservation synchronization application 117 synchronizes information from the secondary database 107 with information in the primary database 109. In one embodiment, information on the primary system 102 always supersedes information in the secondary system 103. This protocol maintains business confidence for the users of the primary system 102 during entry of reservations. Employees at the primary system 102, e.g., site employees, may be quoting reservation information in person to a customer, such as available times, available tables, and so on. During this customer interaction, the site employee may feel confident that a synchronization operation will not supersede the verbal commitment that has been made.

After waiting a predesignated time interval, the reservation synchronization application 117, residing on the primary system 102 as described above, retrieves entries from the queue table 116 of the secondary system 103 (block 210). The reservation synchronization application 117 then scans the queue table 116 for unposted, or unprocessed, entries (diamond 211).

Where an unposted entry is found in the queue table 116 (the ‘yes’ prong of diamond 211), the reservation synchronization application 117 executes the entry against the relevant table on the primary database 109 (block 210). The entry in the queue table 116 is then marked, to indicate that the entry has been processed (block 213). The process of finding an entry, executing the entry against the relevant table, and marking the entry as posted, is repeated until all entries in the queue table 116 of the secondary system 103 have been processed.

In one embodiment, the entries in the queue table 116 comprise SQL commands. The reservation synchronization application 117 retrieves each of the these SQL commands and executes them against the appropriate table of the database 109 of the primary system 102. Once the command is executed, the entry in the queue table 116 is updated to indicate that that command has been processed. In other words, the tables of the primary system 102 are synchronized with the unprocessed entries in the queue table 116 of the secondary system 103.

Where no unposted entries remain in the queue table 116, the queue table 122 of the primary system 102 is retrieved by the reservation synchronization application 117 (block 214). In one embodiment, the reservation synchronization application 117 uses the queue table 122 of the primary system 102 to update tables in the database 107 of the secondary system 103.

The operations are analogous to operations performed with the queue table 116. An unposted entry in the queue table 122 is identified (diamond 215). The table identified by the entry is updated, this time, however, in the secondary database 107 (block 216). Thus, for example, an unposted entry in the queue table 122 may cause the customer table 114 of the secondary system 103 to be updated. Following the relevant table update, the queue table 122 of the primary system 102 is marked as processed (block 217). Blocks 215, 216, and 217 are repeated until all unposted entries in the queue table 122 are processed.

In one embodiment, when the reservation synchronization application 117 retrieves the queue table 122 from the primary system 102 (block 214), the information in the queue table 122 is cached, such as in a temporary memory. Accordingly, although the entries are marked as posted in the queue table 122, the cached entries are retrieved by the reservation synchronization application 117 (block 218). The tables of the primary system 102 are next updated, according to the cached entries (block 219). The cached entries reflect the entries of the queue table 122 which were unposted prior to updating the secondary database 107 (e.g., block 216).

The final update of the primary database 109 using the queue table 122 of the primary system 102 ensures that site-based (e.g., from the primary system 102) reservation updates which are in conflict with web-based (e.g., from the secondary system 103) reservation updates, made during the polling operation, are resolved in favor of the primary database 109. By giving priority to the primary system 102, business confidence in the reservation system 100 is maintained.

Where no conflicts between the primary system 102 and the secondary system 103 occur during the polling operation of FIG. 8, the primary database 109 and the secondary database 107 are identical following the polling operation. By keeping the predesignated time interval, e.g., the interval between conducting the polling operation, short, the likelihood of such conflict is diminished, according to one embodiment.

Using the polling operation of FIG. 8, the reservation system 100 thus maintains mostly redundant databases while permitting reservations to be entered both at the site, from the primary system 102 and from a customer's computer which accesses the secondary system 103. As the secondary (web server) system 103 is available to virtually anyone with web access, the number of sources for entering reservations is almost limitless.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method for scheduling reservations comprising:
storing a site-based reservation on a primary database;
storing a web-based reservation on a secondary database; and
periodically and automatically synchronizing the primary database with the secondary database.

2. The method of claim 1, periodically and automatically synchronizing the primary database with the secondary database further comprising:
identifying secondary updates made to the secondary database;
performing the secondary updates on the primary database;
identifying primary updates made to the primary database;
performing the primary updates on the secondary database; and
performing the primary updates on the primary database.

3. The method of claim 2, storing a web-based reservation on a secondary database further comprising:
accessing a table on the secondary database; and
indicating the access in a queue table.

4. The method of claim 3, identifying secondary updates made to the secondary database further comprising:
retrieving the queue table on the secondary database; and
identifying an unprocessed entry in the queue table.

5. The method of claim 4, identifying an unprocessed entry in the queue table further comprising:
identifying a structured query language command; and
finding a mark associated with the structured query language command, wherein the mark denotes that the command is unprocessed.

6. The method of claim 5, performing the secondary updates on the primary database further comprising:
executing the structured query language command on the primary database.

7. The method of claim 2, performing the primary updates on the primary database further comprising keeping a cache of the operations performed when performing the primary updates on the secondary database.

8. A reservation system comprising:
a system database for storing site-based reservations; and
a synchronization program which, upon execution:
identifies web-based reservations made to a server database;
adds the web-based reservations to the system database;
adds the site-based reservations to the server database; and
adds the site-based reservations to the system database.

9. The reservation system of claim 8, wherein the synchronization program is executed periodically at a predetermined time interval.

10. The reservation system of claim 9, wherein the predetermined time interval is approximately fifteen seconds.

11. The reservation system of claim 9, further comprising a web server including:
the server database; and
an interface for receiving the web-based reservations.

12. The reservation system of claim 11, wherein the interface comprises a web page.

13. The reservation system of claim 9, wherein the processor-based system further comprises a program for receiving the site-based reservations.

14. The reservation system of claim 8, wherein the system database further comprises:
a scheduling table for storing scheduling information;
a customer table for storing customer information; and
a queue table for storing update information.

15. The reservation system of claim 14, wherein the system database further comprises a configuration table for storing configuration information.

16. The reservation system of claim 15, further comprising a reservation system application which retrieves scheduling information from and publishes scheduling information to the scheduling table.

17. The reservation system of claim 16, wherein the reservation system application further retrieves customer information from and publishes customer information to the customer table.

18. The reservation system of claim 16, wherein the reservation system application further program retrieves configuration information from and publishes configuration information to the configuration table.

19. The reservation system of claim 14, wherein the update information comprises updates made to the schedule table and the customer table.

20. The reservation system of claim 11, wherein the server database further comprises:
a scheduling table for storing scheduling information;
a customer table for storing customer information;
a configuration table for storing configuration information; and
a queue table for storing update information.

21. The reservation system of claim 20, wherein the interface retrieves configuration information from the configuration table.

22. The reservation system of claim 20, wherein the interface retrieves customer information from and publishes customer information to the customer table.

23. The reservation system of claim 20, wherein the interface retrieves scheduling information from and publishes scheduling information to the scheduling table.

24. An article comprising a medium storing instructions for enabling a processor-based system to:
store a site-based reservation on a primary database;
store a web-based reservation on a secondary database; and
periodically and automatically synchronize the primary database with the secondary database.

25. The article of claim 24, further storing instructions for enabling a processor-based system to:
identify secondary updates made to the secondary database;
perform the secondary updates on the primary database;
identify primary updates made to the primary database;
perform primary updates on the secondary database; and
perform primary updates on the primary database.
